(19) United States
(12) Patent Application Publication
(10) Pub. No.: US 2008/0166504 A1
(43) Pub. Date: Jul. 10, 2008

(54) Sculptural flowers with flexibility connected petals

(75) Inventor: Margaret Weiser, Tarzana, CA (US)

Correspondence Address: Cislo & Thomas LLP, 1333 2nd Street, Suite #500, Santa Monica, CA, 90401-4110, US

(73) Assignee: Exhart Environmental Systems, Inc.

(21) Appl. No.: 11/540,838

(22) Filed: Sep. 29, 2006

(51) Int. Cl. B44F 7/00

(52) U.S. Cl. 428/15

(57) ABSTRACT

An apparatus and a method involving a novelty item apparatus, having a flat surface for facilitating laying the apparatus on a horizontal surface, mounting the apparatus to a vertical surface, and mounting the apparatus into a permeable material using an elongated member. The apparatus further involves flexibly connected moveable parts for providing environmental whimsy. The apparatus generally involves a body and at least one appendage being coupled to the body using a structure for flexibly connecting the at least one appendage to the body. The apparatus has sculptural features and mechanically responds to wind or other incident forces in a displaceably suspended manner, i.e., springing reaction to an incident force.

### TECHNICAL FIELD

The present invention generally technically relates to novelty items. More particularly, the present invention technically relates to novelty items having moveable parts. Even more particularly, the present invention technically relates to novelty items having flexibly connected moveable parts for providing environmental whimsy.

### BACKGROUND ART

Many novelty items currently exist in the related art for decorating the environment. Such novelty items include faux topiary, faux plants, pink flamingos, jockey statues, gnome figurines, Greek and Roman deity statues, cherubim figurines, friezes, totem poles, gargoyles, bronze statues, cast resin figurines, weathervanes, and holiday yard decorations. However, these related art novelty items tend to be static and to lack sufficient humor or whimsy.

Thus, a need is seen to exist in the related art for an apparatus and method involving novelty items having a flat surface and flexibly mounted moveable parts for providing environmental comedic whimsy.

### DISCLOSURE OF THE INVENTION

In providing a solution to the foregoing and other known problems and disadvantages inherent in the related art, the present invention involves a novelty item apparatus, having a flat surface for facilitating laying the apparatus on a horizontal surface, mounting the apparatus to a vertical surface using a fastener such as a nail, a screw, a molly-bolt, and a dowel, and mounting the apparatus into a permeable material using an elongated member. The apparatus further involves flexibly connected moveable parts for providing environmental whimsy. The present invention novelty apparatus generally comprises a body and at least one appendage being coupled to the body. The apparatus further comprises a structure for flexibly connecting the at least one appendage to the body. The body comprises a flat surface. The at least one appendage is coupled to the body in a manner such as being integrally formed with the body and being flexibly connected to the body by the flexibly connecting structure. The flat surface comprises a structure for mounting the apparatus into a permeable material for providing environmental comedic whimsy. The permeable material comprises at least one material such as a soil, a potting soil, a foam, a fiberglass, a polystyrene foam, a vermiculite, a gravel bed, a rock bed, and a sand. The mounting structure comprises a mounting recess formed in the flat surface for accommodating an elongated member having proximal and distal ends. The present apparatus comprises sculptural features and mechanically responds to wind or other incident forces in a displaceably suspended manner, i.e., springing reaction to an incident force. The appendage responds to an incident force, e.g., wind, by flapping, fluttering, swinging, or the like in a whimsical or comical manner, relative to the body.

The present method of fabricating a novelty apparatus generally comprising the steps of providing a body and providing at least one appendage being coupled to the body. The present method further comprises the step of providing a structure for flexibly connecting the at least one appendage to the body. The body providing step comprises providing the body with a flat surface. The at least one appendage providing step comprises the step of coupling the at least one appendage to the body in a manner such as integrally forming the at least one appendage with the body and flexibly connecting the at least one appendage to the body by the flexibly connecting structure. The flat surface providing step comprises the step of providing a structure for mounting the apparatus into a permeable material for providing environmental comedic whimsy. The mounting structure providing step comprises the step of providing the permeable material as at least one material such as a soil, a potting soil, a foam, a fiberglass, a polystyrene foam, a vermiculite, a gravel bed, a rock bed, and a sand. The mounting structure providing step comprises the step of forming a mounting recess in the flat surface for accommodating an elongated member having proximal and distal ends.

Advantages of the present invention include movability by incident force, such as wind, to create a natural interaction with the environment, mountability to a horizontal surface, a vertical surface, or into a permeable material, and providing comedic whimsy. Other features of the present invention are disclosed, or are apparent, in the section entitled “Mode(s) for Carrying-Out the Invention,” disclosed, infra.

### BRIEF DESCRIPTION OF THE DRAWING

For a better understanding of the present invention, reference is made to the below-referenced accompanying Drawing(s). Reference numbers refer to the same or equivalent parts of the present invention throughout the several figures of the Drawing(s).

FIG. 1A is a top perspective view of a novelty apparatus in the form of a sculptural flower with flexibly connected petals, by example only, in accordance with the present invention.

FIG. 1B is a top perspective view of a novelty apparatus in the form of a sculptural flower with flexibly connected petals, by example only, in accordance with an alternative embodiment of the present invention.

FIG. 2A is a front view of a novelty apparatus in the form of a sculptural flower with flexibly connected petals, by example only, in accordance with the present invention.

FIG. 2B is a front view of a novelty apparatus in the form of a sculptural flower with flexibly connected petals, by example only, in accordance with an alternative embodiment of the present invention.

FIG. 3A is a rear view of a novelty apparatus in the form of a sculptural flower with flexibly connected petals, by example only, in accordance with the present invention.

FIG. 3B is a rear view of a novelty apparatus in the form of a sculptural flower with flexibly connected petals, by example only, in accordance with an alternative embodiment of the present invention.

FIG. 4A is a side view of a novelty apparatus in the form of a sculptural flower with flexibly connected petals, by example only, in accordance with the present invention.

FIG. 4B is a side view of a novelty apparatus in the form of a sculptural flower with flexibly connected petals, by example only, in accordance with an alternative embodiment of the present invention.

FIG. 5A is an opposing side view of a novelty apparatus in the form of a sculptural flower with flexibly connected petals, by example only, in accordance with the present invention.

FIG. 5B is an opposing side view of a novelty apparatus in the form of a sculptural flower with flexibly connected petals, by example only, in accordance with an alternative embodiment of the present invention.

FIG. 6A is a top view of a novelty apparatus in the form of a sculptural flower with flexibly connected petals, by example only, in accordance with the present invention.

FIG. 6B is a top view of a novelty apparatus in the form of a sculptural flower with flexibly connected petals, by example only, in accordance with an alternative embodiment of the present invention.

FIG. 7A is a bottom view of a novelty apparatus in the form of a sculptural flower with flexibly connected petals, by example only, in accordance with the present invention.

FIG. 7B is a bottom view of a novelty apparatus in the form of a sculptural flower with flexibly connected petals, by example only, in accordance with an alternative embodiment of the present invention.

### MODE(S) FOR CARRYING-OUT THE INVENTION

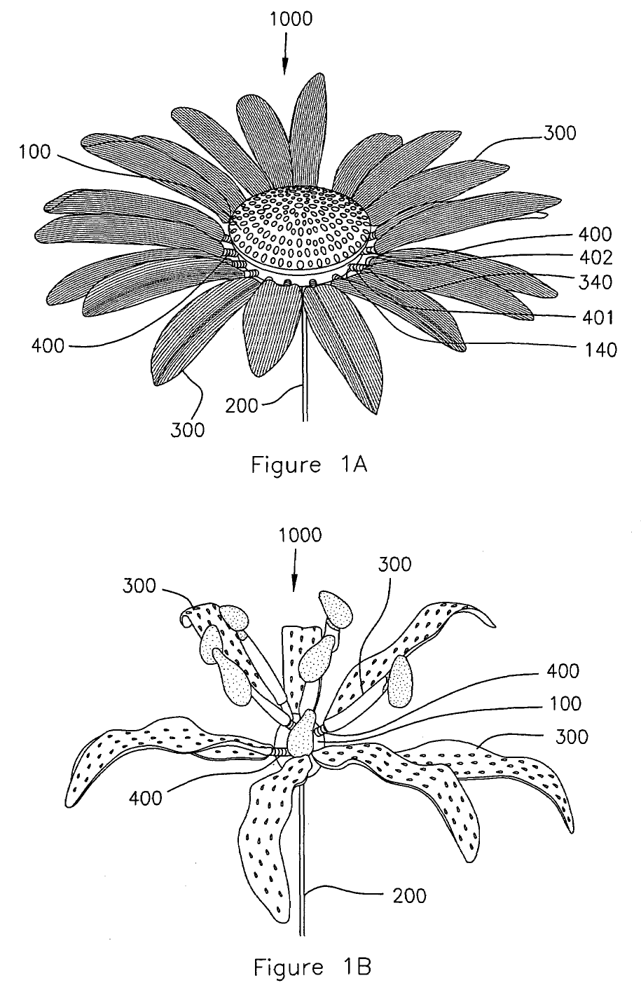

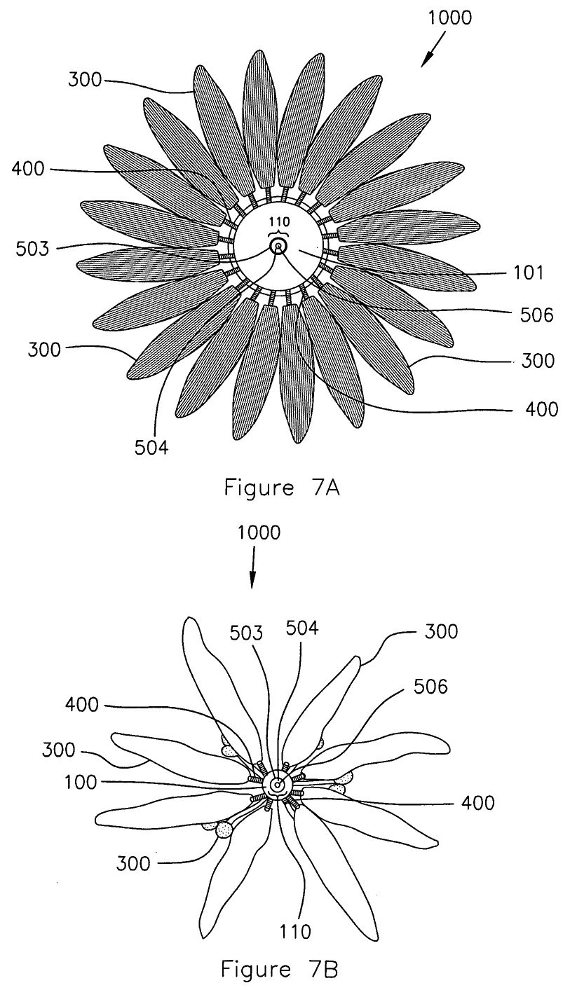

FIGS. 1A and 1B illustrate, in top perspective views, a novelty apparatus 1000, in accordance with the present invention and in accordance with an alternative embodiment of the present invention respectively. The novelty apparatus 1000 comprises a body 100 and at least one appendage 300 being coupled to the body 100. The apparatus 1000 further comprises a structure 400 for flexibly connecting the at least one appendage 300 to the body 100. The body 100 comprises a flat surface 101 (FIG. 7A). The at least one appendage 300 is coupled to the body 100 in a manner such as being integrally formed with the body 100 and being flexibly connected to the body 100 by the flexibly connecting structure 400. The flat surface 101 comprises a structure 110 for mounting the apparatus 1000 into a permeable material (not shown) for providing environmental comedic whimsy (FIG. 7A). The permeable material comprises at least one material selected from a group consisting essentially of a soil, a potting soil, a foam, a fiberglass, a polystyrene foam, a vermiculite, a gravel bed, a rock bed, and a sand.

Still referring to FIGS. 1A and 1B, the at least one appendage 300 comprises at least one configuration such as a corolla, a calyx, a pistil, a stamen, a sepal, a leaf, a stigma, a style, an anther, a filament, an ovary, a flower hip, and a petal. The flexibly connecting structure 400 comprises at least one element such as a flexible member, a spring, a coil spring, and a leaf spring. The flexibly connecting structure 400 comprises a proximal end 401 and a distal end 402. The body 100 comprises at least one body recess 140 corresponding to the at least one appendage 300 for accommodating the proximal end 401; and each at least one appendage 300 comprises a recess 340 for accommodating the distal end 402, wherein the flexibly connecting structure 400 is attached to the body 100 and to the corresponding at least one appendage 300 by at least one structure such as an adhesive and a molded polymer.

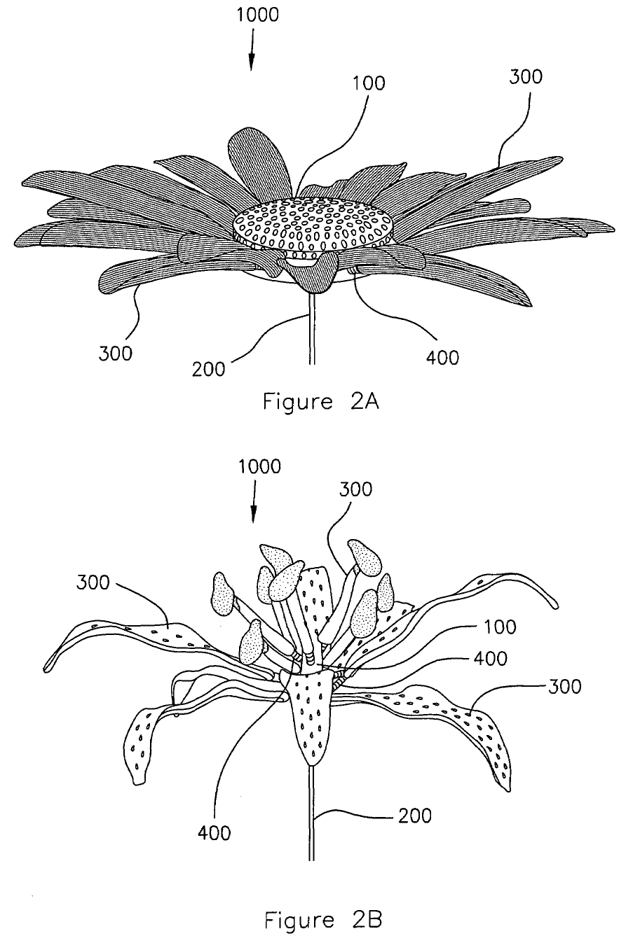

FIGS. 2A and 2B illustrate, in front views, a novelty apparatus 1000, in accordance with the present invention and in accordance with an alternative embodiment of the present invention respectively. Appendages 300 are shown to be flexibly connected to the body 100 by flexibly connecting structures 400, for example only.

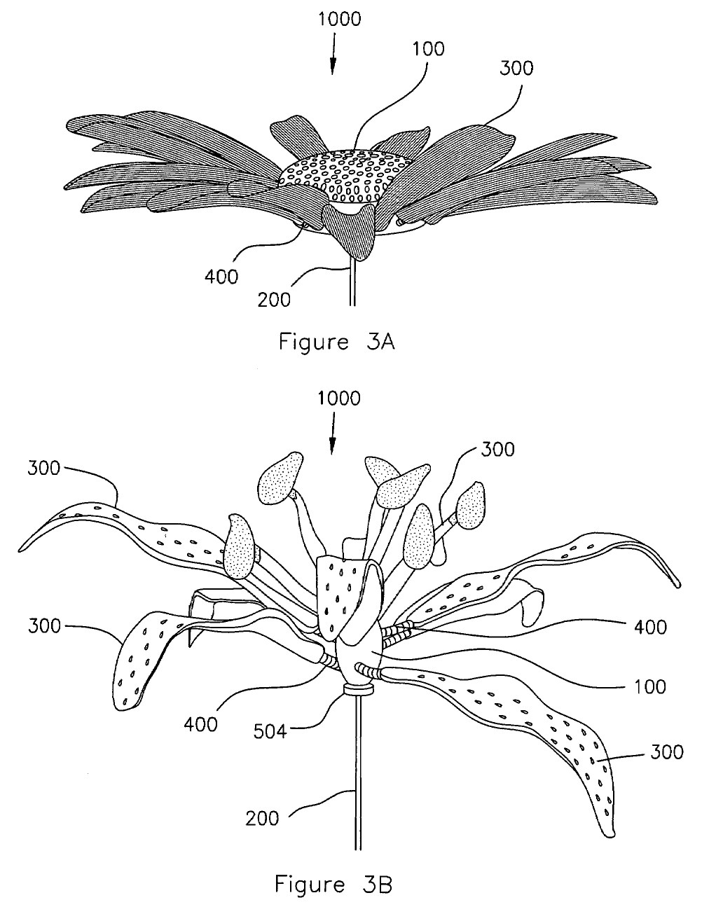

FIGS. 3A and 3B illustrate, in rear views, a novelty apparatus 1000, in accordance with the present invention and in accordance with an alternative embodiment of the present invention respectively. Appendages 300 are shown to be flexibly connected to the body 100 by flexibly connecting structures 400, for example only.

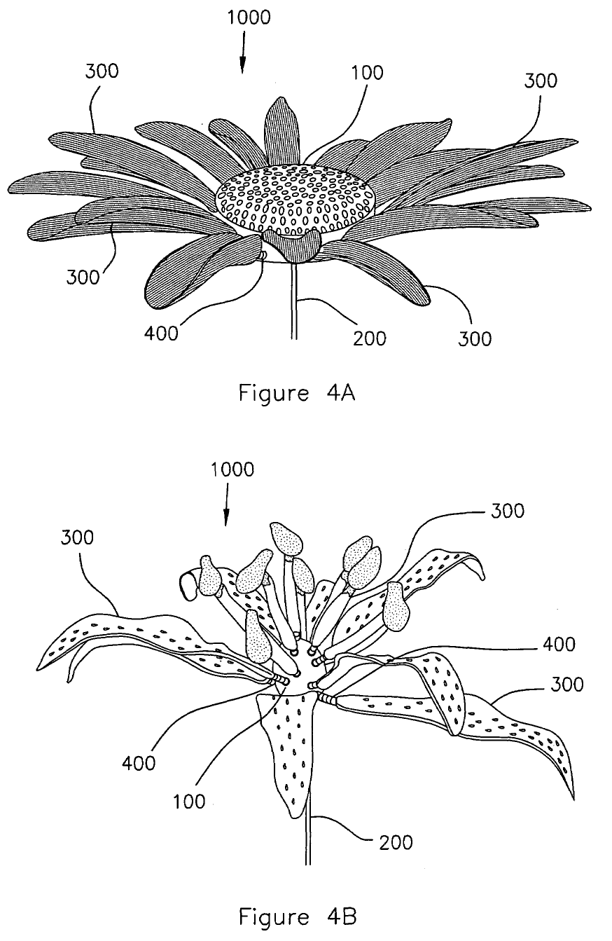

FIGS. 4A and 4B illustrate, in side views, a novelty apparatus 1000, in accordance with the present invention and in accordance with an alternative embodiment of the present invention respectively. Appendages 300 are shown to be flexibly connected to the body 100 by flexibly connecting structures 400, for example only.

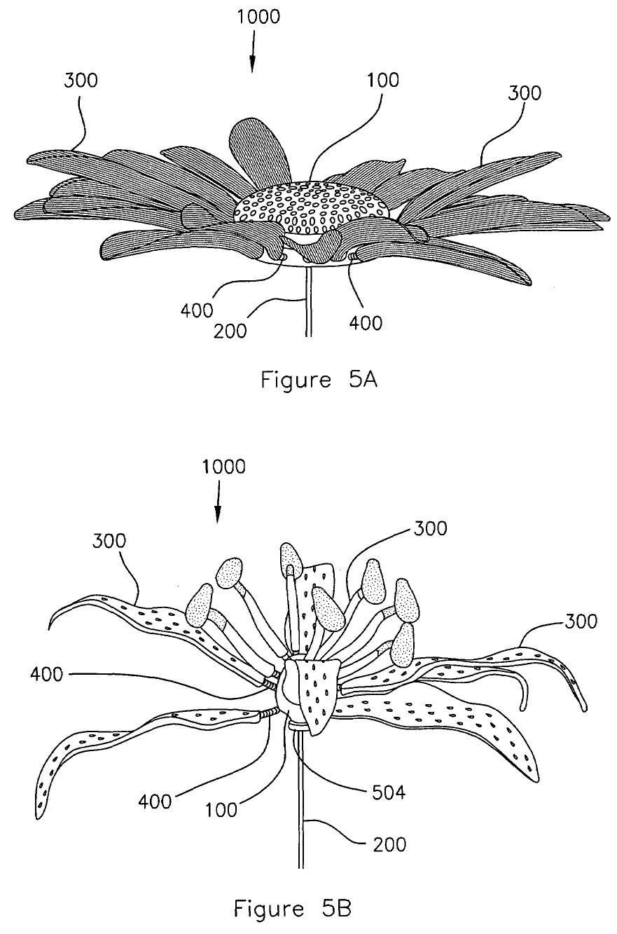

FIGS. 5A and 5B illustrate, in opposing side views, a novelty apparatus 1000, in accordance with the present invention and in accordance with an alternative embodiment of the present invention respectively. Appendages 300 are shown to be flexibly connected to the body 100 by flexibly connecting structures 400, for example only.

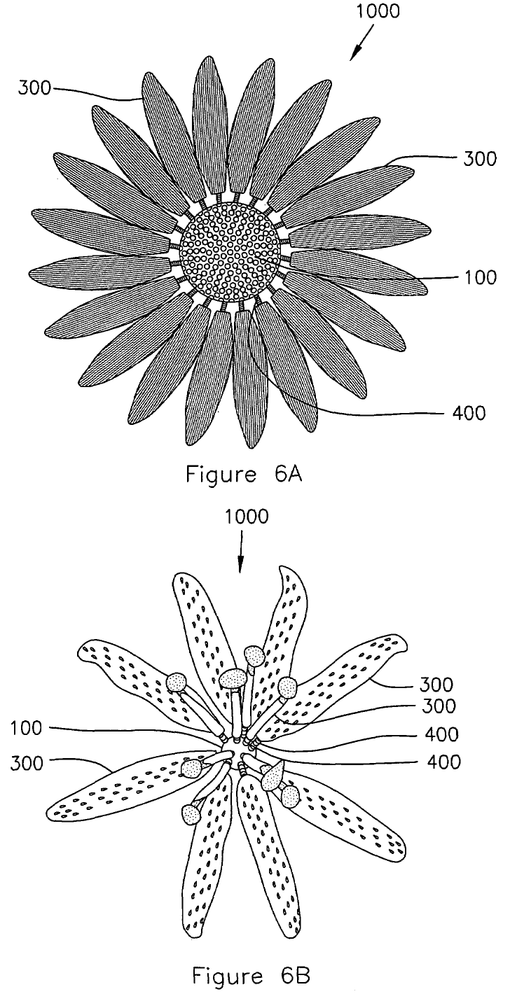

FIG. 6A and 6B illustrate, in top views, a novelty apparatus 1000, in accordance with the present invention and in accordance with an alternative embodiment of the present invention respectively. Appendages 300 are shown to be flexibly connected to the body 100 by flexibly connecting structures 400, for example only.

FIG. 7A and 7B illustrate, in bottom views, a novelty apparatus 1000, in accordance with the present invention and in accordance with an alternative embodiment of the present invention respectively. Appendages 300 are shown to be flexibly connected to the body 100 by flexibly connecting structures 400, for example only. In one embodiment of the present invention, the mounting structure 500 comprises a mounting recess 503 formed in the flat surface 101 for accommodating an elongated member 200 having proximal and distal ends, 201, 202, respectively (FIG. 7A). The mounting structure 500 further comprises a reinforcement member 504 disposed in the mounting recess 503. The reinforcement member 504 comprises a tap hole 506 for accommodating the elongated member proximal end 201. The elongated member 200 comprises a structure in a configuration of a stem.

The present method M of fabricating a novelty apparatus 1000 comprises the steps of providing a body 100 and providing at least one appendage 300 being coupled to the body 100. The method M further comprises the step of providing a structure 400 for flexibly connecting the at least one appendage 300 to the body 100. The body 100 providing step comprises providing the body 100 with a flat surface 101. The at least one appendage 300 providing step comprises the step of coupling the at least one appendage 300 to the body 100 in a manner such as integrally forming the at least one appendage 300 with the body 100 and flexibly connecting the at least one appendage 300 to the body 100 by the flexibly connecting structure 400. The flat surface 101 providing step comprises the step of providing a structure 500 for mounting the apparatus 1000 into a permeable material (not shown) for providing environmental comedic whimsy.

Further, in the method M, the mounting structure 500 providing step comprises the step of providing the permeable material as at least one material such as a soil, a potting soil, a foam, a fiberglass, a polystyrene foam, a vermiculite, a gravel bed, a rock bed, and a sand. In one embodiment of the present invention, the mounting structure 500 providing step comprises the step of forming a mounting recess 503 in the flat surface 101 for accommodating an elongated member 200 having proximal and distal ends 201, 202, respectively (FIG. 7A). The mounting structure 500 providing step further comprises the step of providing a reinforcement member 504 disposed in the mounting recess 503. The reinforcement member 504 providing step comprises providing a tap hole 506 for accommodating the elongated member proximal end 201. The mounting structure 500 providing step comprises the step of providing the elongated member 200 as a structure in a configuration of a stem.

Also in the method M, the at least one appendage 300 providing step comprises the step of providing at least one configuration such as a corolla, a calyx, a pistil, a stamen, a sepal, a leaf, a stigma, a style, an anther, a filament, an ovary, a flower hip, and a petal. The flexibly connecting structure 400 providing step comprises the step of providing at least one element such as a flexible member, a spring, a coil spring, and a leaf spring. The flexibly connecting structure 400 providing step comprises the step of providing a proximal end 401 and a distal end 402. The body 100 providing step comprises the step of providing at least one body recess 140 corresponding to the at least one appendage 300 for accommodating the proximal end 401; and the at least one appendage 300 providing step comprises the step of providing each at least one appendage 300 with an appendage recess 340 for accommodating the distal end 402, wherein the flexibly connecting structure 400 providing step comprises the step of attaching the flexibly connecting structure 400 to the body 100 and to the corresponding at least one appendage 300 by at least one structure such as an adhesive and a molded polymer.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, that various changes and modifications in form, material, and fabrication material may be made, without departing from the spirit and scope of the inventions as set forth in the appended claims, should be readily apparent to those of ordinary skill in the art. No claim herein is to be construed under the provisions of 35 U.S.C. §112, sixth paragraph, unless the element is expressly recited using the phrase “means for.”

### INDUSTRIAL APPLICABILITY

The present invention industrially applies relates to novelty items. More particularly, the present invention industrially applies to novelty items having moveable parts. Even more particularly, the present invention industrially applies to novelty items having flexibly connected moveable parts for providing environmental whimsy.

What is claimed:

1. A novelty apparatus, comprising:
a body;
at least one appendage being coupled to the body; and
means for flexibly connecting the at least one appendage to the body, wherein the body comprises a flat surface,
wherein the at least one appendage is coupled to the body in a manner selected from a group consisting essentially of being integrally formed with the body and being flexibly connected to the body by the flexibly connecting means,
wherein the flat surface comprises means for mounting the apparatus into a permeable material for providing environmental comedic whimsy,
wherein the permeable material comprises at least one material selected from a group consisting essentially of a soil, a potting soil, a foam, a fiberglass, a polystyrene foam, a vermiculite, a gravel bed, a rock bed, and a sand,
wherein the mounting means comprises a mounting recess formed in the flat surface for accommodating an elongated member having proximal and distal ends,
wherein the mounting means further comprises a reinforcement member disposed in the mounting recess,
wherein the reinforcement member comprises a tap hole for accommodating the elongated member proximal end,
wherein the elongated member comprises a structure in a configuration of a stem,
wherein the at least one appendage comprises at least one configuration selected from a group consisting essentially of a corolla, a calyx, a pistil, a stamen, a sepal, a leaf, a stigma, a style, an anther, a filament, an ovary, a flower hip, and a petal,
wherein the flexibly connecting means comprises at least one element selected from a group consisting essentially of a flexible member, a spring, a coil spring, and a leaf spring,
wherein the flexibly connecting means comprises a proximal end and a distal end,
wherein the body comprises at least one body recess corresponding to the at least one appendage for accommodating the proximal end,
wherein each at least one appendage comprises an appendage recess for accommodating the distal end, and
wherein the flexibly connecting means is attached to the body and to the corresponding at least one appendage by at least one structure selected from a group consisting essentially of an adhesive and a molded polymer.

2. A novelty apparatus, comprising:
a body;
at least one appendage being coupled to the body by way of a flexibly connecting member; and
a support for supporting the body in a decorative fashion, whereby the body is supported to allow the at least one appendage to flex relative to the body in a gentle wind.

3. A novelty apparatus, comprising:
a body; and
at least one appendage being coupled to the body.

4. An apparatus, as recited in claim 3, further comprising means for flexibly connecting the at least one appendage to the body.

5. An apparatus, as recited in claim 3, wherein the body comprises a flat surface.

6. An apparatus, as recited in claim 4, wherein the at least one appendage is coupled to the body in a manner selected from a group consisting essentially of being integrally formed with the body and being flexibly connected to the body by the flexibly connecting means.

7. An apparatus, as recited in claim 5, wherein the flat surface comprises means for mounting the apparatus into a permeable material for providing environmental comedic whimsy.

8. An apparatus, as recited in claim 7, wherein the permeable material comprises at least one material selected from a group consisting essentially of a soil, a potting soil, a foam, a fiberglass, a polystyrene foam, a vermiculite, a gravel bed, a rock bed, and a sand.

9. An apparatus, as recited in claim 7, wherein the mounting means comprises a mounting recess formed in the flat surface for accommodating an elongated member having proximal and distal ends.

10. An apparatus, as recited in claim 9, wherein the mounting means further comprises a reinforcement member disposed in the mounting recess.

11. An apparatus, as recited in claim 10, wherein the reinforcement member comprises a tap hole for accommodating the elongated member proximal end.

12. An apparatus, as recited in claim 9, wherein the elongated member comprises a structure in a configuration of a stem.

13. An apparatus, as recited in claim 3, wherein the at least one appendage comprises at least one configuration selected from a group consisting essentially of a corolla, a calyx, a pistil, a stamen, a sepal, a leaf, a stigma, a style, an anther, a filament, an ovary, a flower hip, and a petal.

14. An apparatus, as recited in claim 4, wherein the flexibly connecting means comprises at least one element selected from a group consisting essentially of a flexible member, a spring, a coil spring, and a leaf spring.

15. An apparatus, as recited in claim 4,
wherein the flexibly connecting means comprises a proximal end and a distal end,
wherein the body comprises at least one body recess corresponding to the at least one appendage for accommodating the proximal end, and
wherein each at least one appendage comprises an appendage recess for accommodating the distal end.

16. An apparatus, as recited in claim 4, wherein the flexibly connecting means is attached to the body and to the corresponding at least one appendage by at least one structure selected from a group consisting essentially of an adhesive and a molded polymer.

17. A method of fabricating a novelty apparatus, comprising the steps of:
providing a body; and
providing at least one appendage being coupled to the body.

18. A method, as recited in claim 17, further comprising the step of providing means for flexibly connecting the at least one appendage to the body.

19. A method, as recited in claim 17, wherein the body providing step comprises providing the body with a flat surface.

20. A method, as recited in claim 18, wherein the at least one appendage providing step comprises the step of coupling the at least one appendage to the body in a manner selected from a group consisting essentially of integrally forming the at least one appendage with the body and flexibly connecting the at least one appendage to the body by the flexibly connecting means.

21. A method, as recited in claim 19, wherein the flat surface providing step comprises the step of providing means for mounting the apparatus into a permeable material for providing environmental comedic whimsy.

22. A method, as recited in claim 21, wherein the mounting means providing step comprises the step of providing the permeable material as at least one material selected from a group consisting essentially of a soil, a potting soil, a foam, a fiberglass, a polystyrene foam, a vermiculite, a gravel bed, a rock bed, and a sand.

23. A method, as recited in claim 21, wherein the mounting means providing step comprises the step of forming a mounting recess in the flat surface for accommodating an elongated member having proximal and distal ends.

24. A method, as recited in claim 23, wherein the mounting means providing step further comprises the step of providing a reinforcement member disposed in the mounting recess.

25. A method, as recited in claim 24, wherein the reinforcement member providing step comprises providing a tap hole for accommodating the elongated member proximal end.

26. A method, as recited in claim 23, wherein the mounting means providing step comprises the step of providing the elongated member as a structure in a configuration of a stem.

27. A method, as recited in claim 17, wherein the at least one appendage providing step comprises the step of providing at least one configuration selected from a group consisting essentially of a corolla, a calyx, a pistil, a stamen, a sepal, a leaf, a stigma, a style, an anther, a filament, an ovary, a flower hip, and a petal.

28. A method, as recited in claim 18, wherein the flexibly connecting means providing step comprises the step of providing at least one element selected from a group consisting essentially of a flexible member, a spring, a coil spring, and a leaf spring.

29. A method, as recited in claim 18,
wherein the flexibly connecting means providing step comprises the step of providing a proximal end and a distal end,
wherein the body providing step comprises the step of providing at least one body recess corresponding to the at least one appendage for accommodating the proximal end, and
wherein the at least one appendage providing step comprises the step of providing each at least one appendage with an appendage recess for accommodating the distal end.

30. A method, as recited in claim 18, wherein the flexibly connecting means providing step comprises the step of attaching the flexibly connecting means to the body and to the corresponding at least one appendage by at least one structure selected from a group consisting essentially of an adhesive and a molded polymer.

31. A method, as recited in claim 17, further comprising the step of providing means for flexibly connecting the at least one appendage to the body,
wherein the body providing step comprises providing the body with a flat surface,
wherein the at least one appendage providing step comprises the step of coupling the at least one appendage to the body in a manner selected from a group consisting essentially of integrally forming the at least one appendage with the body and flexibly connecting the at least one appendage to the body by the flexibly connecting means,
wherein the flat surface providing step comprises the step of providing means for mounting the apparatus into a permeable material for providing environmental comedic whimsy,
wherein mounting means providing step comprises the step of providing the permeable material as at least one material selected from a group consisting essentially of a soil, a potting soil, a foam, a fiberglass, a polystyrene foam, a vermiculite, a gravel bed, a rock bed, and a sand,
wherein the mounting means providing step comprises the step of forming a mounting recess in the flat surface for accommodating an elongated member having proximal and distal ends,
wherein the mounting means providing step further comprises the step of providing a reinforcement member disposed in the mounting recess,
wherein the reinforcement member providing step comprises providing a tap hole for accommodating the elongated member proximal end,
wherein the mounting means providing step comprises the step of providing the elongated member as a structure in a configuration of a stem,
wherein the at least one appendage providing step comprises the step of providing at least one configuration selected from a group consisting essentially of a corolla, a calyx, a pistil, a stamen, a sepal, a leaf, a stigma, a style, an anther, a filament, an ovary, a flower hip, and a petal,
wherein the flexibly connecting means providing step comprises the step of providing at least one element selected from a group consisting essentially of a flexible member, a spring, a coil spring, and a leaf spring,
wherein the flexibly connecting means providing step comprises the step of providing a proximal end and a distal end,
wherein the body providing step comprises the step of providing at least one body recess corresponding to the at least one appendage for accommodating the proximal end,
wherein the at least one appendage providing step comprises the step of providing each at least one appendage with an appendage recess for accommodating the distal end, and
wherein the flexibly connecting means providing step comprises the step of attaching the flexibly connecting means to the body and to the corresponding at least one appendage by at least one structure selected from a group consisting essentially of an adhesive and a molded polymer.
